(19) United States
(12) Patent Application Publication
(10) Pub. No.: US 2006/0241956 A1
(43) Pub. Date: Oct. 26, 2006

(54) Transforming business models

(75) Inventors: Marc Levy, Woodinville, WA (US); Ulrich Homann, Kirkland, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/112,777

(22) Filed: Apr. 22, 2005

(51) Int. Cl. G06Q 99/00

(52) U.S. Cl. 705/1

(57) ABSTRACT

The present invention extends to transforming business models. A business model representing a business layer of a business architecture is accessed. An indication that the business model is to be transformed is received. Transformations can include transforming the level of detail in a business model of transforming a business model representing one business layer into a business model representing another different business layer. Transform relationships that designate how business models are to be transformed are accessed. Business models are transformed in accordance with the transform relationships and transformed models are created. Accordingly, users are provided business context for completing tasks more efficiently without being overwhelmed by unneeded business details and without lacking all the relevant business details.

### CROSS-REFERENCE TO RELATED APPLICATIONS

Not applicable.

### BACKGROUND OF THE INVENTION

1. The Field of the Invention

The present invention relates to business modeling and, more particularly, to transforming business models.

2. The Relevant Technology

Businesses have complex operations. An understanding of these operations is important to a business in order to, for example, prepare for change, account for costs, etc. Accordingly, various mechanisms have been developed to model and represent businesses. Some mechanisms include manual generation of diagrams that represent business processes that describe how work is done. For example, trained individuals can analyze all aspects of a business to identify business capabilities and interrelationships and interdependencies between the business processes. Based on the analysis, the trained individuals can generate the representative diagrams. However, accurate analysis of a business from a business process point-of-view can take an extended period of time due to complexity of business. Further, once representative diagrams are generated such diagrams are not easily modified or partitioned to isolate aspects of interest or analysis.

Unfortunately, since many business processes are dynamic (i.e., can change over time), a manually generated representation of business processes may be outdated before it is even completed. Further, even if a manually generated representation of business processes were accurate at the time it was completed, any change in business processes after the business representation is generated would cause the business representation to be incorrect. Thus, manually generated representations provide limited, if any, ability for a business to determine how simulated and/or hypothetical changes to various business capabilities would affect the business, in part drive by the complexity and necessary completeness of manual presentation. Hiding details or providing different views to simplify analysis requires additional, manual efforts that are expensive and potentially error prone.

At least in part as a result of the deficiencies in manually generated business representations, some computerized mechanisms have been developed to generate business representations. These computerized mechanisms use various techniques to represent business and the required business functions mostly focused on modeling business processes and detailed procedures that support those processes. For example, some computerized mechanisms present a graphical view of business processes at a user-interface. To some limited extent, these graphical views can be altered to simulate the effect of different business capabilities on a business.

However, most of these computerized mechanisms focus on “how” the business is executed, conflating (or combining) various different layers (or types) of input data, such as, for example, organizational structures, procedures, process flows, and supporting technology. The stability of the input data (i.e., the half life of the information represented) potentially varies dramatically between the different input layers (or types), rendering the useful life time of a generated view only as valid as the least stable input. Conflating (or combining) interrelated, yet non-dependent, input data together can also result in obscured views of how a business functions and lead to unnecessary and costly improvement efforts of the modeled business, without the ability to determine the effect of changes in each individual layer.

Further, computerized mechanisms often include hard-coded data types and hard-coded representations for business modeling input data. These hard-coded data types and representations can be difficult to alter without access to source code. Thus, the flexibility and extensibility of modeling businesses and generating corresponding views is limited. For example, it may difficult to alter pre-defined data formats such that a business capability can be represented in a different way or such that a previously undefined business capability can be added.

All of the above for mentioned difficulties associated with modeling businesses limit the usefulness of visual presentations of such models. For example, most visual presentations of business models, such as, for example, business maps, center on data representations in the context of specific isolated tasks or activities. Visualizing and navigating to adjunct, potentially useful business data, organizations structure, partners, or relevant business process flows, is cumbersome and often impossible. For example, there is typically no mechanism to visually navigate from data in one business layer, such as, for example, a business process flow layer, to data in another business layer, such as, for example, a organizational structure layer indicating personnel that implement/manage a business process flow. This inability to efficiently navigate can prevent analysis of different views of a business and selection of connected entities.

Further, both manually generated and computer generated models are typically unstructured, and thus lack any mechanism to provide varied levels of detail. For example, it is difficult (and essentially impossible with manually generated models) to efficiently generate a single model that can provide both a higher level view (e.g., for senior management) and at the same time a lower level view (e.g., for those employees implementing the business function) of the same business function. Further, these modeling techniques typically lack any mechanism to view various different portions of a business function model at different levels of detail. For example, it is difficult, if not impossible, to simultaneously view a first portion of a model at one level of detail and a second different portion of the model at a second different level of detail.

Additionally, these techniques typically generate business models that lack formal operators. Thus, even computer generated models may have limited usefulness since there is no way to manipulate the computer generated models. Without formal operators there may be no way to transform different portions of a business model to have different corresponding levels of detail. For example, there may be no way to transform a portion of a model from more a detailed view to less detailed view (zooming out) or vice versa (zooming in). Thus, a user may be forced to use a business map (or portion there of) having either to much or to little detail for a specific task. As a result, on one hand, a user may get bogged down in unnecessary details that make performing the task inefficient. On the other hand, a user may lack sufficient details for completing the task at all.

Also, without formal operators, there may be no way to transform components of one type of business model into corresponding components of another type of business model. For example, there may be no way to transform components of a business process flow model into corresponding components of a service network model. Accordingly, what would be advantageous are systems, methods, computer program products, and data structures for transforming business models.

### BRIEF SUMMARY OF THE INVENTION

The foregoing problems with the prior state of the art are overcome by the principles of the present invention, which are directed towards methods, systems, computer program products, and data structures for transforming business models. In some embodiments, a computer system accessing a business model representing a business layer of a business architecture. The business model models a plurality of business components of the business layer, with an initial level of detail, in accordance with a structured data model. The computer system receiving an indication that one or more of the plurality of business components are to be modeled with an updated level of detail.

The computer system accesses transform relationships that designate how business components are to be transformed from the initial level of detail to the updated level of detail. The computer system transforms the one or more business components from the initial level of detail to the updated level of detail in accordance with the transform relationships. The computer system models the one or more business components with the updated level of detail such that one portion of the accessed business model retains the initial level of detail and another portion of the accessed business model is updated to the updated level of detail.

In other embodiments, a computer system accessing a first structured business model representing a first business layer of a business architecture. The first structured business model models one or more first business layer components of the first business layer in accordance with a structured data model. The computer system receives an indication that the first structured business model is to be transformed into a second business model representing a second business layer of the business architecture.

The computer system accesses transform relationships that designate how components of the first business layer are to be transformed into corresponding second business layer components of the second business layer. The computer system transforms the one or more first business layer components into corresponding second business layer components in accordance with the transform relationships. The computer system models the second business layer components into the second business model.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an example computer architecture that can be used to transform business models.

FIG. 2 illustrates an example capability modeling schema that can be used for efficiently and flexibly business modeling based upon structured business capabilities.

FIG. 3 illustrates an example flowchart of a method for transforming a portion of a business model to have a different level of detail.

FIG. 4 illustrates an example flowchart of a method for transforming components of one type of business model into corresponding components of another type of business model.

FIGS. 5A, 5B, 5C, 5D, and 5E illustrate different example diagrammatic representations of connect business components

FIGS. 6A, 6B, and 6C illustrate a first example of transforming a portion of a business model to have a different level of detail.

FIGS. 7A, 7B, and 7C illustrate a second example of transforming a portion of a business model to have a different level of detail.

FIG. 8 illustrates a model of a business capability layer and a corresponding transformed model of a service network layer.

FIG. 9 illustrates a suitable operating environment for the principles of the present invention.

### DETAILED DESCRIPTION OF THE PREFERRED EMBODIMENTS

The principles of the present invention provide for transforming business models. In some embodiments, a computer system accessing a business model representing a business layer of a business architecture. The business model models a plurality of business components of the business layer, with an initial level of detail, in accordance with a structured data model. The computer system receiving an indication that one or more of the plurality of business components are to be modeled with an updated level of detail.

The computer system accesses transform relationships that designate how business components are to be transformed from the initial level of detail to the updated level of detail. The computer system transforms the one or more business components from the initial level of detail to the updated level of detail in accordance with the transform relationships. The computer system models the one or more business components with the updated level of detail such that one portion of the accessed business model retains the initial level of detail and another portion of the accessed business model is updated to the updated level of detail.

In other embodiments, a computer system accessing a first structured business model representing a first business layer of a business architecture. The first structured business model models one or more first business layer components of the first business layer in accordance with a structured data model. The computer system receives an indication that the first structured business model is to be transformed into a second business model representing a second business layer of the business architecture.

The computer system accesses transform relationships that designate how components of the first business layer are to be transformed into corresponding second business layer components of the second business layer. The computer system transforms the one or more first business layer components into corresponding second business layer components in accordance with the transform relationships. The computer system models the second business layer components into the second business model.

Embodiments within the scope of the present invention include computer-readable media for carrying or having computer-executable instructions or data structures stored thereon. Such computer-readable media may be any available media, which is accessible by a general-purpose or special-purpose computer system. By way of example, and not limitation, such computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “computer network” is defined as one or more data links that enable the transport of electronic data between computer systems and/or modules. When information is transferred or provided over a computer network or another communications connection (either hardwired, wireless, or a combination of hardwired or wireless) to a computer system, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general-purpose computer system or special-purpose computer system to perform a certain function or group of functions. The computer executable instructions may be, for example, binaries, intermediate format instructions such as assembly language, or even source code.

In this description and in the following claims, a “computer system” is defined as one or more software modules, one or more hardware modules, or combinations thereof, that work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a mobile phone or Personal Digital Assistant “PDA”) where internal modules (such as a memory and processor) work together to perform operations on electronic data.

In this description and the following claims, a “business layer” is defined as a view of specified characteristics of a business. For example, a business can be viewed based on its organizational structure, its business capabilities, it business processes, its service network, its geographic location, etc. Thus, a business can include a corresponding organizational layer, capability layer, process flow layer, service network layer, geographical layer, etc.

In this description and the following claims “business architecture” is defined as the overall design of at least a portion of a business. A business architecture for a company or one or more portions of a company can include one or more business layers that span various boundaries inside and/or outside of the company. For example, a company's business architecture can span externally physical boundaries (e.g., walls, buildings, etc.), internally physical boundaries (e.g., divisions, departments, etc.), and logical boundaries (e.g., a fiscal year end, a perceived service boundary, security etc.). Thus, an outsourced business capability can be viewed as part of the business architecture for a company even though the outsourced business capability is not performed by the company. Business architectures can be past, current (as-is), or future (to-be) architectures of an entire business or one or more portions of a business. A portion of a business can include e a specific sub-network or set of sub-networks of business capabilities.

Generally, the stability (or volatility) of different types of business models corresponding to different business layers can vary. That is, one type of business model can be more or less stable relative to other types of business models. For example, a business procedure model modeling business procedures may be more stable than a business organizational model modeling business organizational structure. On the other hand, business procedure modeling business procedures may be less stable than a business capability model modeling business capabilities.

In this description and in the following claims, a “business attribute” is defined as any attribute that can be used to model a business or part of a business. Different business modeling attributes can correspond to modeling different aspects (or different layers) of a business architecture. Thus, business modeling attributes can generally be divided into subsets of different types of business modeling attributes, such as, for example, business organizational attributes, business procedure attributes, business process flow attributes, business capability attributes, geographic attributes, etc.

Accordingly, each different type of business attributes can be used to model business components of a corresponding business aspect (or business layer). For example, business organizational attributes can be used to model business organizational structures, business procedure attributes can be used to model business procedures, business process flow attributes can be used to model business process flows, business capability attributes can be used to model business capabilities, geographic attributes can be used to model geography, etc.

In this description and in the following claims, a “business attribute relationship” is defined as an attribute that can be used to model a relationship between a first business attribute (of a first business component) and a second different business attribute (of a second business component). A relationship can be, for example, a dependency, a connection, or a boundary. A dependency can indicate what has to occur modeled business component to start, external events that that occur for a business component to stop, or other business components that depend on the business component. A connection indicates how one business component relates to other business components. A boundary indicates if influences on a business component are internal (e.g., people, process, technology inside a company) or external (e.g., regulations, customers, partners) to the business component. A business attribute relationship can be used to model a relationship between business components in the same business layer or between business components in different business layers.

Accordingly, each different type of business attribute relationship can be used to model business components of a corresponding business aspect (or business layer). For example, business organizational attribute relationships can be used to model business organizational structures, business procedure attribute relationships can be used to model business procedures, business process flow attribute relationships can be used to model business process flows, business capability attribute relationships can be used to model business capabilities, geographic attribute relationships can be used to model geography, etc.

Thus, in this description and in the following claims, a “business component” is defined as component of a business model, such as, for example, a component of a model of business organizational structures, business procedures, business process flows, business capabilities, geography, etc., with respect to a particular business layer. Further, it would be apparent to one skilled in the art, after having reviewed this description, that other subsets of business components, in additional to those expressly described, can be used to model other corresponding business aspects (or business layers).

In this description and in the following claims, a “schema” is defined as an expression of a shared vocabulary between a plurality of computer systems or modules that allows the plurality of computer systems or modules to process data according the expressed shared vocabulary. A schema can define and describe classes of data using constructs (e.g., name/value pairs) of a schema language. The schema constructs can be used to constrain and document the meaning, usage, and relationships of data types, elements and their content, attributes and their values, entities and their contents, and notations, as used in a specified application, such as, for example, a business capability model. Thus, any computer system or module that can access a schema can process data in accordance with the schema. Further, any computer system or module that can access a schema can compose or modify data for use by other computer systems and/or modules that can also access the schema.

A schema can be utilized to define virtually any data type including logical, binary, octal, decimal, hexadecimal, integer, floating-point, character, character string, user-defined data types, and combinations of these data types used to defined data structures. Some examples of user-defined data types are business capability properties, business capability inputs and outputs, business capability processes, business capability connections, and business capability service level expectations. A data type can also be defined to reference of link to other data types in a schema hierarchy.

An eXtensible Markup Language (“XML”) schema is one example of a type of schema. An XML schema can define and describe a class of XML documents using schema constructs (e.g., name/value pairs) of an XML schema language. These schema constructs can be used to constrain and document the meaning, usage, and relationships of data types, elements and their content, attributes and their values, entities and their contents, and notations, as used in XML documents. Thus, schema is also defined to include Document Type Definitions (“DTD”), such as, for example, DTD files ending with a “.dtd” extension and World Wide Web Consortium (“W3C”) XML Schemas, such as, for example, XML Schema files ending with a “.xsd” extension. However, the actually file extension for a particular DTD or XML schema is not important.

Those skilled in the art will appreciate that the invention may be practiced in a computer network environments with many types of computer system configurations, including, personal computers, laptop computers, hand-held devices, multi-processor systems, microprocessor-based or programmable consumer electronics, network PCs, minicomputers, mainframe computers, mobile telephones, PDAs, pagers, and the like. The invention may also be practiced in distributed system environments where local and remote computer systems, which are linked (either by hardwired data links, wireless data links, or by a combination of hardwired and wireless data links) through a computer network, both perform tasks. In a distributed system environment, program modules may be located in both local and remote memory storage devices.

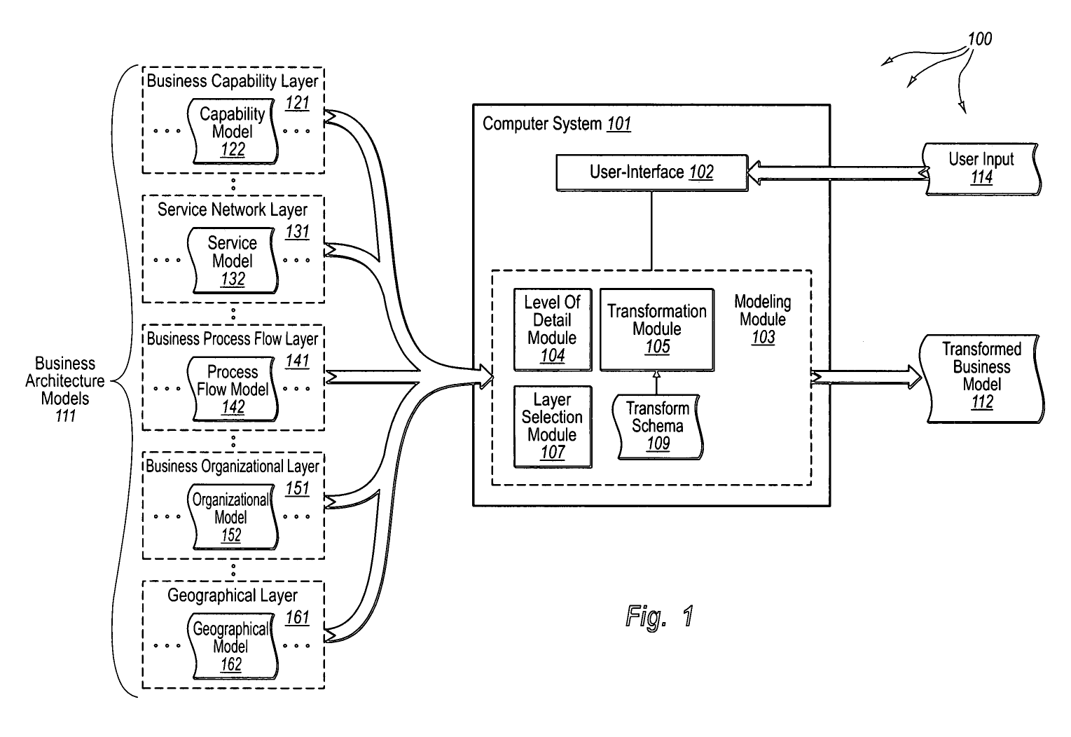

FIG. 1 illustrates an example computer architecture 100 that can be used to transform business models. As depicted in computer architecture 100, computer system 101 includes user-interface 102 and modeling module 103. User-interface 102 is configured to interface between a computer system user and computer system 101. User-interface 102 can provide an interface for the computer system user to enter user-input 114 (e.g., selecting operations to perform on models) into modeling module 103 and to view output from modeling module 103.

Generally, modeling module 103 can include modules configured to modle business components. For example as depicted in computer architecture 100, modeling module 103 includes transform schema 109, level of detail module 104, transform module 105, and layer selection module 107.

Transform module 105 is configured to utilize transform schema 109 to transform between business components having varied levels of detail and/or between corresponding business components of different business layers. Transformation schema 109 can include transformation relationships that designate how business components of a business layer are to be transformed between different levels of detail and/or how business components of one business layer are to be transformed to business components of another business layer. Transform module 105 can be configured to transform business components between a plurality of different levels of detail and/or between a plurality of different business layers.

Level of detail module 104 is configured to control levels of detail within a business model. For example, level of detail module 104 can hide or provide details within a model in response to user-input. Thus, level of detail module 104 can cause less than all the data in business attribute and business attribute relationship to be modeled.

Level of detail module 104 can also alter a level of detail such that a current level of detail is increased or decreased. For example, level of detail module 104 can focus (or “zoom-in”) on levels of detail as requested by a user (e.g., to drill down on a specified part of a business model). On the other hand, level of detail module 104 can also abstract (or “zoom-out”) levels of detail as requested by a user (e.g., to provide an overview of part of a business model). Level of detail module 104 can also model different portions of a business model with different levels of detail. Using varied levels of detail can facilitate drilling down into a specified portion of a business model in increased detail and yet still providing context (i.e., reduced detail surrounding components) for the increased detail portions.

Layer selection module 107 is configured to determine a destination business layer. Business components of a current business layer can be transformed to corresponding business components of the destination business layer. Layer selection module 107 can filter business attributes and business attribute relationships for business components of other business layers that are not to be transformed such that transform module 105 does not receive business attributes and business attribute relationships for filtered layers. In response to user-input, filtered and non-filtered layers can be changed. Thus, additional business layers can be subsequently transformed.

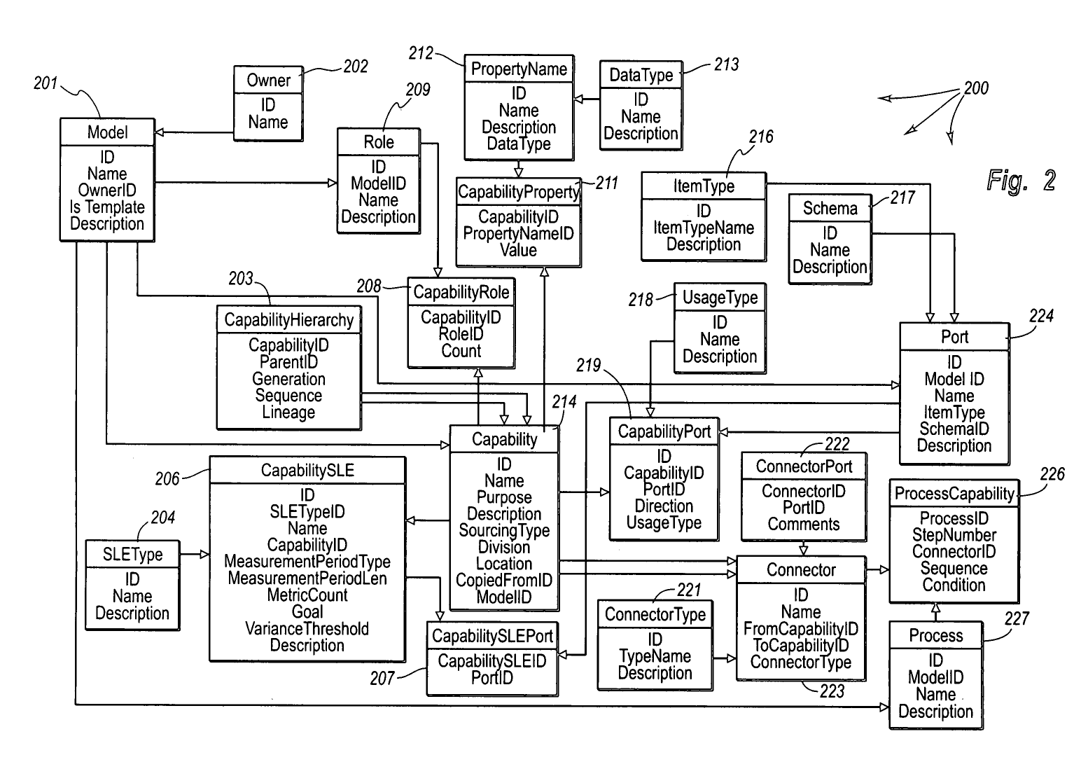

Generally, computer system 101 is configured to receive business models generated in accordance with appropriate data models, unstructured business models, and/or unstructured business data. In response to receiving unstructured business models and/or unstructured business data, computer system 101 can refer to the appropriate data models to generate business models in accordance with the data models. FIG. 2 depicts one example of a business capability modeling schema 200 that will be described in further detail below.

A business layer within a business architecture can be modeled using a single data model. For example, it may be that a single business capability data model is used to model a business capability layer of a business architecture. However, a business layer can also be modeled using any of a plurality different data models. For example, it may be that any of a plurality of different business capability data models is used to model a business capability layer of a business architecture.

Further, the same business layer within different business architectures can be modeled using the same data model or similar data models. For example, it may be that the same data model is used to model a business capability layer of a first business architecture is also used to model a corresponding business capability layer of a second business architecture. In this description and in the following claims, a “similarly typed business models” are defined as models based on the same data model or similar data

However, different data models can be used to model the same business layer within different business architectures. For example, it may be that a first business capability data model is used to a model a business capability layer of a first business architecture and a second business capability data model is used to model a business capability layer of a second business architecture. Additionally, different data models can be used to model different business layers of the same business architecture. For example, it may be that a business capability data model is used to model a business capability layer of a business architecture and a service network data model is used to model a service network layer of the business architecture.

Thus, computer system 101 can access business models corresponding to different business layers (e.g., business capability layer 121, service network layer 131, business process flow layer 141, business organizational layer 151, geographic layer 161, etc.). For example, computer system 101 can access one or more of capability model 122, service model 132, process flow model 142, and organizational model 152, and geographic model 162. A vertical series of two consecutive periods (a vertical ellipsis) before, between, and after the expressly depicted layers represents that computer architecture. 100 can include other additional layers. A horizontal series of two consecutive periods (an ellipsis) before, between, and after the expressly depicted models in each layer represents that each layer can include other additional models. Collectively, the models 122, 132, 142, 152, and 162 represent business architecture 111.

Modeling module 103 can perform transform operations (e.g. transforming business components) on accessed models (potentially in response to user entered commands) and can generate corresponding transformed business models. For example, modeling module 103 can transform the level of detail in a portion of organizational model. Likewise, modeling module 103 can transform business components of process flow model 142 into corresponding business components of geographical layer 161. Modeling module 103 can then model the corresponding geographical business components into a geographical model. Transformed models can be output at user-interface 102, sent to other processing modules for further processing, and/or can be sent via electronic messages to other computer systems.

As previously described, various different data models can be used to model different business layers. Thus in some embodiments, data models can include at least one business capability modeling schema for modeling a business capability layer, at least one business organizational schema for modeling a business organizational layer, at least one business process flow modeling schema for modeling a business process flow layer, at least one service network layer business modeling schema for modeling a service network layer, etc.

In some embodiments, business models and data format definitions can be generally described as indicated in Table 1.

TABLE 1

| | |
|---|---|
| Models | Models serve to group capabilities into distinct |
| | groups that describe a single business. Models |
| | can contain all the capabilities defined for the |
| | business as well as how any defined capabilities |
| | relate to each other in terms of hierarchical |
| | decomposition and process flow relationships. |
| | Models facilitate the segmentation of data in a |
| | repository into distinct business models which |
| | can be compared with one another but are separate |
| | from each other. Further, while capability data |
| | is defined within a model, other data elements |
| | of the data model are outside of the model and |
| | facilitate the comparison of different models |
| | with one another. |
| Capabilities | Capabilities are individual business functional |
| | areas that are modeled in at least three |
| | different ways in the model. Capabilities can be |
| | modeled as individual things with their own set |
| | of properties; as a decomposition hierarchy of |
| | functional areas; and as connected in simple |
| | business process flows. Coarser (or higher level) |
| | capabilities can include a set of more granular |
| | (or lower level) capabilities, such as, for |
| | example, when a higher level capability is |
| | decomposed into its constituent parts. The |
| | assignment of properties to capabilities may |
| | occur at multiple levels in a hierarchy, which |
| | can be used to control later data transformations. |
| | For example, when a higher level capability is |
| | manipulated through a transformation, corre- |
| | sponding lower level capabilities' properties |
| | can be considered in the transformation |
| Capability Inputs | Capability Inputs and Outputs are the artifacts |
| and Outputs | and events that are consumed and/or produced by |
| | business capabilities. They represent what is |
| | outward and visible about the behavior of the |
| | capabilities. Inputs can be consumed and outputs |
| | can be produced independently of other inputs and |
| | outputs. For example, there is no requirement |
| | that all the inputs for a capability be consumed |
| | before the capability starts. Likewise, there is |
| | no requirement that all the processing of a |
| | capability be completed before an output can be |
| | produced. |
| Processes | Processes are networks of business capabilities |
| | that are connected in a flow to illustrate and |
| | end-to-end view of a business process. Processes |
| | define the connections between capabilities that |
| | enable larger business functions. Processes |
| | modeled in the data model can refer to cross- |
| | capability processes that represent traversal of |
| | boundaries between capabilities. |
| Connections | Connections are used to represent relationships |
| | between business capabilities. Connections can be |
| | data connections over which data, such as, for |
| | example, a business document, can flow between |
| | those capabilities. However, other types of |
| | connections are also possible. Connections may |
| | also refer to oversight or management of a |
| | business function, as frequently occurs in |
| | regulated areas of business activity. Connections |
| | can be typed such that connection types are the |
| | same across all models. Typed connections can be |
| | used to facilitate model comparisons. |
| Service Levels | Service levels refer to the general expectation |
| | of the performance of a capability. Service levels |
| | attach performance and accountability attributes |
| | to a capability in varying degrees of formality |
| | (e.g., contractual) and time (e.g., historical, |
| | current, target, and maximum). In some embodiments, |
| | a capability includes a verb and noun phrase (or |
| | such a verb-noun phrase can be construed from the |
| | capability description). Service level descrip- |
| | tive data associated with the capability indicates |
| | how well the capability performs the action |
| | implied by the phrase. For example, Approve Loan |
| | Application might have a service level |
| | expectation of 2 days. |

FIG. 2 illustrates an example business capability modeling schema 200 that can be used for efficiently and flexibly business modeling based upon structured business capabilities. Business capability modeling schema 200 can include data formats for modeling business capability properties, business capability inputs and outputs, business capability processes, business capability connections, and business capability service level expectations. It should be understood that business capability modeling schema 200 can be one of a plurality of schemas that includes data definitions for modeling a corresponding plurality of different business modeling attributes.

Depicted in FIG. 2, schema 200 includes model data format 201. Generally, model data format 201 can be described as indicated in Table 2.

TABLE 2

| Name | Data Type | Description |
|---|---|---|
| ID | int | Key to the model and is used to relate |
| | | other data entities to this model. |
| Name | varchar(150) | A unique name that identifies the model. |
| OwnerID | int | Points to the owner of the model. An |
| | | owner can own many models. |
| IsTemplate | bit | Controls the ability of a modeler to |
| | | modify this model. If this field is |
| | | true, it means that this model is to |
| | | be used as a template for other models |
| | | and can thus be used to compare the |
| | | derived models, even after properties |
| | | are changed by modelers in the derived |
| | | models. Therefore, this model cannot |
| | | be changed by normal editors of models. |
| | | Defaults to false |
| Description | varchar(2000) | Textual description of the model. |

Depicted in FIG. 2, schema 200 includes owner data format 202. Generally, owner data format 202 can be described as indicated in Table 3.

TABLE 3

| Name | Data Type | Description |
|---|---|---|
| ID | int | Key to the owner and is used to relate other |
| | | data entities to this owner. |
| Name | varchar(50) | Unique name of the owner. |

Depicted in FIG. 2, schema 200 includes capability data format 214. Generally, capability data format 214 can be described as indicated in Table 4.

TABLE 4

| Name | Data Type | Description |
|---|---|---|
| ID | int | Key to the capability and is used to |
| | | relate other data entities to this |
| | | capability. |
| Name | varchar(256) | Name that is unique within a particular |
| | | model. |
| Purpose | varchar(1000) | Short description of the capability. |
| Description | varchar(8000) | A more detailed description of the |
| | | capability and may explain relationships |
| | | and properties of this capability as |
| | | well as the capability itself. |
| SourcingType | int | This field can have three values: |
| | | Internal, Outsourced, or Both. It |
| | | indicates whether or not the capability |
| | | is performed by an organization that |
| | | is internal (part of) the organization |
| | | that “owns” the model; or an |
| | | organization that is a supplier of the |
| | | capability to the “owner” of the model; |
| | | or it is performed by both internal |
| | | and external suppliers. |
| Division | varchar(100) | Identifies the business organizational |
| | | area where a capability is performed. |
| Location | varchar(100) | Geographical location where the |
| | | capability is performed. |
| CopiedFromID | int | Indicates the specific capability (and |
| | | hence template model) from which this |
| | | capability was copied. Can be a system- |
| | | set value. |
| ModelID | int | Indicates the model to which this |
| | | capability belongs. |

Depicted in FIG. 2, schema 200 includes capability hierarchy data format 203. Generally, capability hierarchy data format 203 can be described as indicated in Table 5.

TABLE 5

| Name | Data Type | Description |
|---|---|---|
| Capability ID | int | Links to a capability. |
| ParentID | int | Links to a capability in the same model |
| | | and indicates the parent of this |
| | | capability in a hierarchical view of |
| | | the model's capabilities. |
| Generation | int | Part of the lineage key which is used |
| | | in certain queries. |
| Sequence | int | Part of the lineage key which is used |
| | | in certain queries. |
| Lineage | varchar(20) | Indicates the entire ancestral lineage |
| | | of a capability and used to perform |
| | | hierarchical sorts. |

Depicted in FIG. 2, schema 200 includes capability property data format 211. Generally, capability property data format 211 can be described as indicated in Table 6.

TABLE 6

| Name | Data Type | Description |
|---|---|---|
| CapabilityID | int | Links to a capability. |
| PropertyNameID | int | Links to a user-defined property. |
| Value | varchar(250) | Yalue of the property for this |
| | | capability. |

Depicted in FIG. 2, schema 200 includes property name data format 212. Generally, property name data format 212 can be described as indicated in Table 7.

TABLE 7

| Name | Data Type | Description |
|---|---|---|
| ID | int | Key to the property and is used to |
| | | relate this property to capabilities. |
| Name | varchar(250) | Name of the property and is user |
| | | defined. |
| Description | varchar(4000) | Description of what the property is |
| | | and how it is to be used to describe |
| | | capabilities. |
| DataType | int | Links to the DataType entity and |
| | | indicates the type of data that is |
| | | expected when a modeler sets a value |
| | | for this property for a capability. |
| | | If, for example, the modeler defines |
| | | a property named “Fixed Cost Allocation”, |
| | | it is likely that the data type for |
| | | this property would be “Currency”. |

Depicted in FIG. 2, schema 200 includes data type data format 213. Generally, data type data format 213 can be described as indicated in Table 8.

TABLE 8

| Name | Data Type | Description |
|---|---|---|
| ID | int | Key to the data type and is used to |
| | | indicate the data type of a user |
| | | defined property. This is one of a few |
| | | tables that we assume are not modified |
| | | by modelers as the modeling tools rely |
| | | on the values being “known” in order |
| | | to perform validations of property |
| | | values correctly. |
| Name | varchar(20) | A friendly name of the data type. |
| | | Examples are “Integer”, “String”, |
| | | “Currency”, etc. |
| Description | varchar(4000) | Any additional information about the |
| | | data type that would be useful especially |
| | | in guiding user selection of data types |
| | | for the properties that they define. |

Depicted in FIG. 2, schema 200 includes port data format 224. Ports corresponding to a business capability can be used to transfer input into and output out of the corresponding business capability. Generally, port data format 224 can be described as indicated in Table 9.

TABLE 9

| Name | Data Type | Description |
|---|---|---|
| ID | int | Key to the port and is used to relate |
| | | this port to other entities. |
| ModelID | int | Indicates that this port belongs to |
| | | the related model. When dealing with a |
| | | particular model, only the ports |
| | | associated with the model are |
| | | available to the modeler. A port is |
| | | something that is input to - consumed |
| | | by - a capability or output from - |
| | | produced by - a capability. |
| Name | varchar(256) | A unique name within the specific |
| | | model. |
| ItemType | int | Links to the ItemType entity which |
| | | indicates the type of input or output, |
| | | which could be electronic data, a |
| | | physical item, a fax, an event, etc. |
| SchemaID | int | If the itemtype indicates that this is |
| | | an electronic data record of some kind, |
| | | this field links to the schema that |
| | | describes the content of the data |
| | | record. |
| Description | varchar(4000) | A detailed description of the input/ |
| | | output item. |

Depicted in FIG. 2, schema 200 includes capability port data format 219. Generally, capability port data format 219 can be described as indicated in Table 10.

TABLE 10

| Name | Data Type | Description |
|---|---|---|
| ID | int | Key to the capability port and is used |
| | | to relate this port to other entities. |
| CapabilityID | int | Links to the capability that is |
| | | referenced by this relationship. |
| PortID | int | Links to the port that is referenced by |
| | | this relationship. |
| Direction | int | Has three values and indicates whether or |
| | | not the item is input into the referenced |
| | | capability, output from the referenced |
| | | capability, or it flows both directions. |
| UsageType | int | Links to the UsageType entity and |
| | | indicates how the capability uses this |
| | | item. Examples are “Read only”, “Read |
| | | and update”, “Create”, etc. |

Depicted in FIG. 2, schema 200 includes usage type data format 218. Generally, usage type data format 218 can be described as indicated in Table 11.

TABLE 11

| Name | Data Type | Description |
|---|---|---|
| ID | int | Key to the UsageType and is used to |
| | | relate this usage type to the input/ |
| | | output items (port entity). This |
| | | table is assumed to be non-modifiable |
| | | by modelers as the tools rely on its |
| | | specific values to process models. |
| Name | varchar(150) | A unique name that identifies the |
| | | usage type. Examples include “Read |
| | | only”, “Read and update”, |
| | | “Create”, etc. |
| Description | varchar(4000) | A more detailed description of the |
| | | usage type and how the modeling tools |
| | | may behave when dealing with a |
| | | specific usage type. |

Depicted in FIG. 2, schema 200 includes item type data format 216. Generally, item type data format 216 can be described as indicated in Table 12.

TABLE 12

| Name | Data Type | Description |
|---|---|---|
| ID | int | Key to the ItemType and is used to |
| | | relate this item type to the input/ |
| | | output items (port entity). This |
| | | table is assumed to be non-modifiable |
| | | by modelers as the tools rely on its |
| | | specific values to process models. |
| ItemTypeName | varchar(150) | A unique name that identifies the |
| | | usage type. Examples include |
| | | “Electronic data”, “Physical item”, |
| | | “Fax”, etc. |
| Description | varchar(4000) | A more detailed description of the |
| | | item type and how the modeling tools |
| | | may behave when dealing with a |
| | | specific item type. |

Depicted in FIG. 2, schema 200 includes schema data format 217. Generally, schema data format 217 can be described as indicated in Table 13.

TABLE 13

| Name | Data Type | Description |
|---|---|---|
| ID | int | This is the key to the Schema entity |
| | | and is used to relate this item type |
| | | to the input/output items (port entity). |
| Name | varchar(250) | This is a unique name for a schema. |
| Description | varchar(4000) | This may be a detailed description of |
| | | the data content for a data record in |
| | | the form of an XML schema (or some |
| | | simplification thereof). |

Depicted in FIG. 2, schema 200 includes process data format 227. Generally, process data format 227 can be described as indicated in Table 14.

TABLE 14

| Name | Data Type | Description |
|---|---|---|
| ID | int | Key to the Process entity and is used |
| | | to relate this item type to connector |
| | | entities, and through them to the |
| | | related capabilities in the |
| | | ProcessCapability entity. |
| ModelID | int | Indicates the model that these processes |
| | | belong to. |
| Name | varchar(256) | A unique name for a process within |
| | | this model. |
| Description | varchar(4000) | Describes the process that is modeled |
| | | by this entity and the |
| | | ProcessCapability entities. |

Depicted in FIG. 2, schema 200 includes process capability data format 227. Generally, process capability data format 227 can be described as indicated in Table 15.

TABLE 15

| Name | Data Type | Description |
|---|---|---|
| ProcessID | int | Indicates the process that this |
| | | capabilities and connections belong to. |
| StepNumber | int | Indicates the sequence of this |
| | | connection in the process and is used |
| | | to sort the process steps for rendering |
| | | in a visual model. |
| ConnectorID | int | Links to the Connector entity and |
| | | through it to the source and target |
| | | capabilities of a process flow from a |
| | | source capability to a destination |
| | | capability. |
| Sequence | int | Indicates the sequence of a connection |
| | | within a step, thereby supporting |
| | | process flows that have multiple paths |
| | | through it. To define a path where one |
| | | leg has more steps (or flows through |
| | | more capabilities) than another leg, |
| | | the shorter leg is represented by |
| | | entries in this table that reference |
| | | the same connector but different |
| | | StepNumbers. |
| Condition | varchar(4000) | Stores comments on what the conditions |
| | | are that drive the process. |

Depicted in FIG. 2, schema 200 includes connector data format 223. Generally, connecter data format 223 can be described as indicated in Table 16.

TABLE 16

| Name | Data Type | Description |
|---|---|---|
| ID | int | Key to the Connector entity and |
| | | indicates the connection between |
| | | two capabilities. This key is used |
| | | to link this connection to other |
| | | entities. |
| Name | varchar(256) | A comment that is associated with |
| | | this connection between two |
| | | capabilities. |
| FromCapabilityID | int | References the capability that is |
| | | the source capability. Depending |
| | | on the ConnectorType, the meaning |
| | | of being the source capability may |
| | | differ slightly. |
| ToCapabilityID | int | References the capability that is |
| | | the target capability. Depending |
| | | on the ConnectorType, the meaning |
| | | of being the target capability may |
| | | differ slightly. |
| ConnectorType | int | Link to the ConnectorType entity |
| | | and indicates what the relationship |
| | | between the two referenced |
| | | capabilities really means. |
| | | Examples are “Collaborative”, |
| | | “Controlling”, “Dependent”, etc. |

Depicted in FIG. 2, schema 200 includes connector type data format 221. Generally, connecter type data format 221 can be described as indicated in Table 17.

TABLE 17

| Name | Data Type | Description |
|---|---|---|
| ID | int | Key to the ConnectorType entity and is |
| | | used to describe the connection type |
| | | in the Connector entity. |
| TypeName | varchar(50) | A unique name that describes the type |
| | | of connection. Examples are |
| | | “Collaborative”, “Controlling”, |
| | | “Dependent”, etc. |
| Description | varchar(4000) | A detailed description of the |
| | | connection type and helps modelers |
| | | understand what connections mean in |
| | | their models. |

Depicted in FIG. 2, schema 200 includes connector port data format 222. Generally, connecter port data format 222 can be described as indicated in Table 18.

TABLE 18

| Name | Data Type | Description |
|---|---|---|
| ConnectorID | int | A reference to the Connector entity |
| | | and serves to link a specific |
| | | connection between two capabilities |
| | | with a specific input/output item. |
| PortID | int | A reference to the Port entity (input/ |
| | | output item) and serves to identify |
| | | the input/output item that flows along |
| | | a specific connection. |
| Comments | varchar(4000) | More detailed commentary about this |
| | | flow of an item along this connection. |

Depicted in FIG. 2, schema 200 includes role data format 209. Generally, role data format 209 can be described as indicated in Table 19.

TABLE 19

| Name | Data Type | Description |
|---|---|---|
| ID | int | Key to the Role entity and is used to |
| | | relate this role to Capability entities. |
| ModelID | int | Indicates what model this role entity |
| | | belongs to. |
| Name | varchar(100) | A unique name for the role within this |
| | | model. A role describes a type of |
| | | person or user involved in performing |
| | | capabilities. |
| Description | varchar(2000) | Provides a description of the role and |
| | | may provide guidance to modelers in |
| | | their choice of roles to associate |
| | | with capabilities. |

Depicted in FIG. 2, schema 200 includes capability role data format 208. Generally, capability role data format 208 can be described as indicated in Table 20.

TABLE 20

| Name | Data Type | Description |
|---|---|---|
| CapabilityID | int | References a specific capability and |
| | | serves to link that capability with a |
| | | specific role. |
| RoleID | int | References a specific role and links it |
| | | to the referenced capability. |
| Count | int | Indicates the number of people in this |
| | | role that are required to perform this |
| | | capability. A value of ‘0’ indicates |
| | | that the role participation has not been |
| | | quantified. |

Depicted in FIG. 2, schema 200 includes SLE type data format 204. Generally, SLE type data format 204 can be described as indicated in Table 21.

TABLE 21

| Name | Data Type | Description |
|---|---|---|
| ID | int | Key to the SLEType entity and is used |
| | | to relate this role to CapabilitySLE |
| | | entities. |
| Name | varchar(100) | Uniquely names the type of service |
| | | level that is described in this entity. |
| | | This entity is assumed to be read-only |
| | | by modelers because the modeling tools |
| | | rely on the value of these entries to |
| | | visualize service levels. Some values |
| | | for service level types include “Duration”, |
| | | “Throughput”, “Monetary Cost”, “Time |
| | | Cost” and “Concurrency”. |
| Description | varchar(4000) | A detailed description of the service |
| | | level type and how to describe |
| | | specific service levels related to |
| | | capabilities. |

Depicted in FIG. 2, schema 200 includes Capability SLE data format 206. Generally, Capability SLE data format 206 can be described as indicated in Table 22.

TABLE 22

| Name | Data Type | Description |
|---|---|---|
| ID | int | Key to the Role entity and |
| | | is used to relate this role |
| | | to Capability entities. |
| SLETypeID | int | References the SLEType |
| | | entity and identifies a |
| | | specific way to measure a |
| | | service level. |
| Name | varchar(50) | A unique name for the |
| | | service level definition. |
| CapabilityID | int | References the capability |
| | | to which this service level |
| | | applies. |
| MeasurementPeriodType | varchar(50) | Names the unit of measure |
| | | for the service level. For |
| | | “Duration” type service |
| | | levels, this should be a |
| | | time period. For a “Monetary |
| | | Cost” SLE type, “Dollars” |
| | | or “Thousands of dollars” |
| | | would be appropriate. |
| MeasurementPeriodLen | int | If the SLE type references |
| | | a “Throughput” type of |
| | | SLE, this field indicates |
| | | the length of the measure- |
| | | ment period for throughput. |
| MetricCount | int | An actual (current status/ |
| | | performance or historical |
| | | performance) measurement of |
| | | the SLE, such as the number |
| | | of days of duration, the |
| | | number of items completed |
| | | for throughput, the amount |
| | | of dollars for monetary |
| | | cost, etc. |
| Goal | int | A target for future |
| | | performance such as the |
| | | number of days of duration, |
| | | the number of items |
| | | completed for throughput, |
| | | the amount of dollars for |
| | | monetary cost, etc. |
| VarianceThreshold | int | How much variation in |
| | | performance (e.g., from a |
| | | goal) is tolerated before a |
| | | variation is noted or |
| | | notification is sent. For |
| | | example, when a variance |
| | | threshold is exceeded an |
| | | electronic mail message can |
| | | be sent to appropriate |
| | | management personnel |
| Description | varchar(2000) | A detailed description of |
| | | the SLE for this capability. |

Depicted in FIG. 2, schema 200 includes Capability SLE Port data format 207. Generally, Capability SLE port data format 207 can be described as indicated in Table 23.

TABLE 23

| | | |
|---|---|---|
| CapabilitySLEID | int | References a particular service level for |
| | | a specific capability as described in a |
| | | CapabilitySLE entity. It serves to link a |
| | | particular service level to a particular |
| | | input or output item. |
| PortID | int | References a particular input or output |
| | | item of a capability and links a service |
| | | level to the specific item that is being |
| | | measured. For example, this might |
| | | reference mortgage approvals for a |
| | | duration service level for a mortgage |
| | | processing capability and the entire |
| | | service level definition might thereby |
| | | describe that 100 mortgage approvals are |
| | | completed every day for the mortgage |
| | | processing capability. |

It should be understood that schema 100 is merely one example of a business capability modeling schema. Further, modeling business capabilities does not require that capability attributes for all the data formats in schema 200 be accessible. For example, a capability and connecter can be used to model a business capability based on capability data format 214 and connector data format 223, without accessing capability attributes correspond to other data formats. Thus, schema 200 defines data formats for business capability attributes that are accessed, but does not require that all data formats be populated to generate a business capability model.

It would be apparent to one skilled in the art, after having reviewed this description, that embodiments of the present invention can be used with a wide variety of other business capability modeling schemas, in addition to schema 200. It would also be apparent to one skilled in the art, after having reviewed this description, that embodiments of the present invention can be used with a wide variety of other schemas that facilitate modeling other business layers.

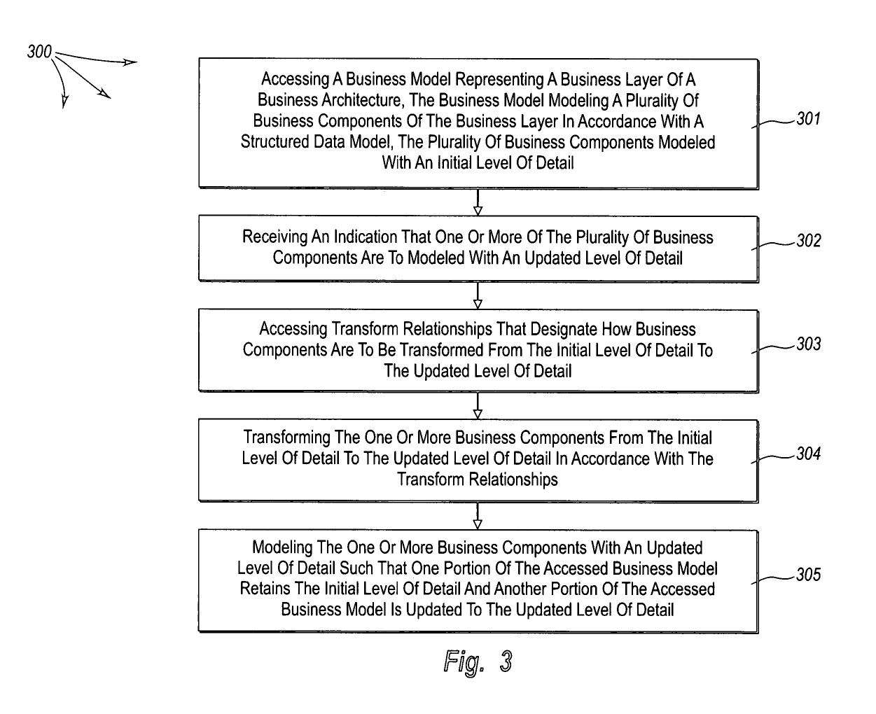

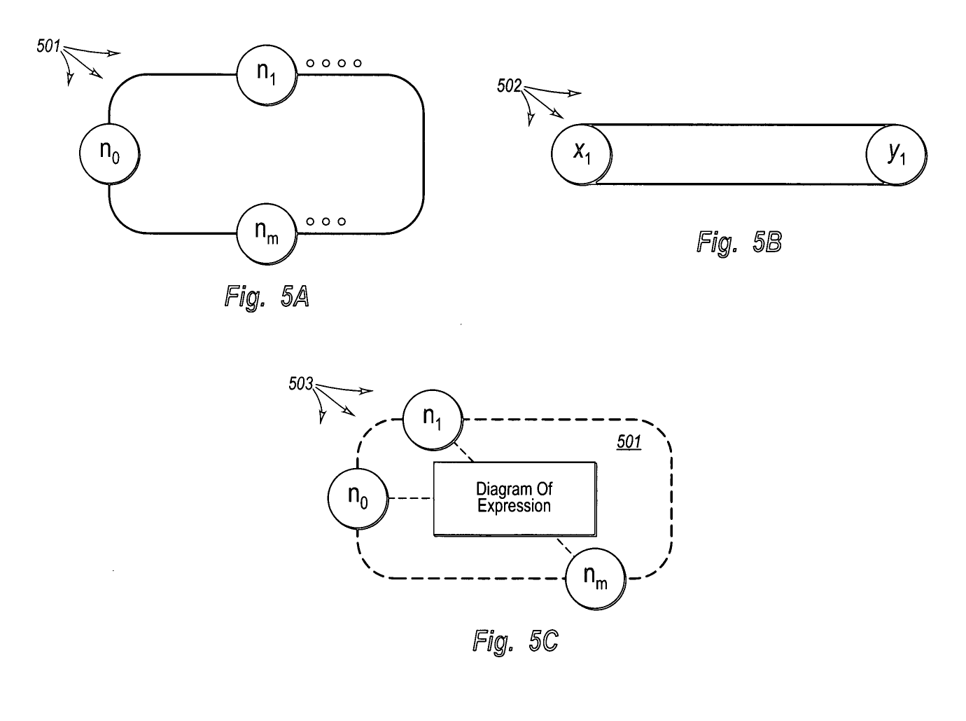

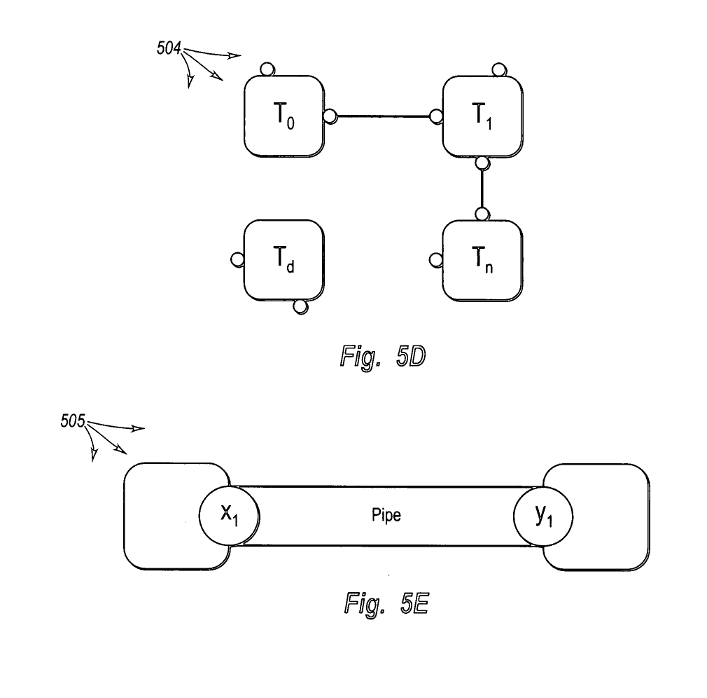

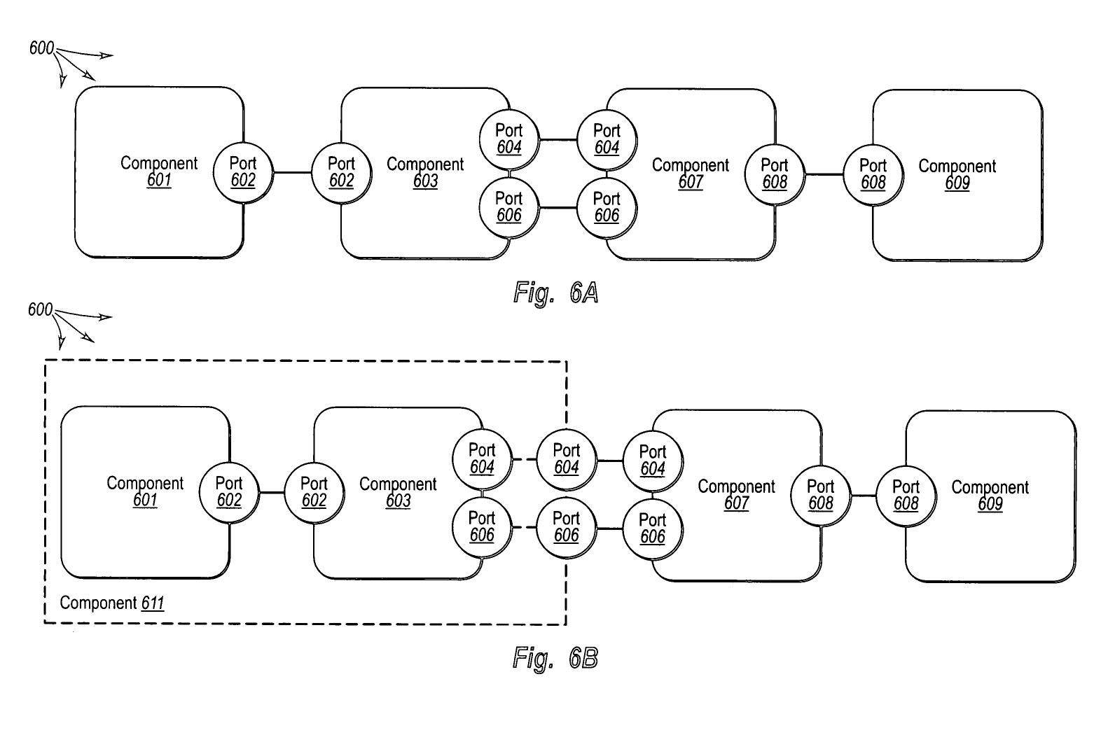

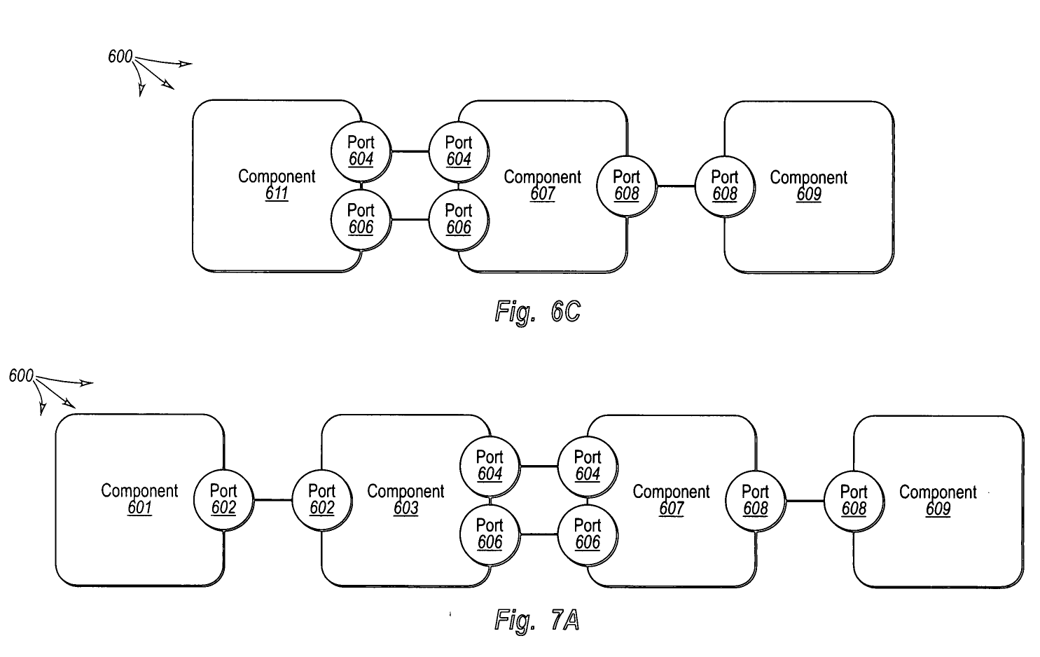

FIG. 3 illustrates an example flowchart of a method 300 transforming the level of detail in a business model. The method 300 will be described with respect to the components and data in architectures 100, the different example diagrammatic representations of connect business components depicted in FIGS. 5A, 5B, 5C, 5D, and 5E, and the example of transforming a portion of a business model to have a different level of detail depicted in FIGS. 6A, 6B, and 6C illustrate a first

Method 300 includes an act of accessing a business model representing a business layer of a business architecture (act 301). For example, computer system 101 can access capability model 122. The business model modeling a plurality of business components of the business layer in accordance with a structured data model. For example, capability model 122 can be model a plurality of business components of business capability layer 121 in accordance with business capability modeling schema 200. The plurality of business components modeled with an initial level of detail.

For example, user-interface 102 can receive user-input 114 indicating an initial level of detail for capability model 122. User-interface 102 can transfer user-input 114 to level of detail module 104. An initial level of detail can indicate that all business components are to have the same level of detail. However, the initial level of detail is configurable across different business comments such that the initial level of detail differs for different business components. Thus, an initial level of detail can indicate that different business components are to have different levels of detail.

The method 300 includes an act of receiving an indication that one or more of the plurality of business components are to be modeled with an updated level of detail (act 302). For example, user-interface 102 can receive user-input 114 indicating that the level of detail for one or more business components of capability model 122 are to be changed. User-interface 102 can transfer user-input 114 to level of detail module 104. Changing a level of detail can include increasing and/or decreasing the level of detail of all, some, or one of the business components in a business model. For example, a second level of detail can indicate that the level of detail for a portion of capability model 112 is to be increased or decreased from the initial level of detail.

The method 300 includes an act of accessing transform relationships that designate how business components are to be transformed from the initial level of detail to the updated level of detail (act 303). For example, transform module 105 can access transform schema 109. Transform schema 109 can include transform relationships that indicate how business components of capability model 122 are to be transformed between various different levels of detail.

A components and connectors algebra can be used to represent transform relationships. A component (e.g., a business component) can be represented as a list of unique names (e.g., relationships to other business components), such as, for example, having the syntax:
COMPONENT ::=[]|[NAME (, NAME)*]

Thus, the expression X=[a, b, c], indicates that the component X includes names a, b, and c. A null component can be represented as [].

Systems of connected components (e.g., connected business components forming a business model) can be represented using expressions. One operation used to connect components is a parallel composition operator resented by ‘|’. Thus, expressions can have, for example, the following syntax:
TERM ::=COMPONENT (EXPRESSION)
EXPRESSION ::=TERM (|TERM)*

The following are examples of expressions:
[a, b]
[a, b]|[c, d]
[a, b]|([b, c]|[b, d])

A decomposition operator (essentially the inverse of the composition operation) can also be used.

Expressions can have values. Values can include either components or composition of components without common names. For example, [a,b]|[c,d] is a value (no common names). On the other hand, [a,b]|[b,c] is not a value (the components share b). Thus, evaluation of expressions can be defined in terms of values suing the following example syntax:
VALUE ::=COMPONENT C₀| . . . |Cₙ with all component pairs without common name
TERM ::=VALUE (EXPRESSION)
EXPRESSION ::=TERM (|TERM)*

An evaluation function can be defined as Eval: Expressions→Values (C for components, V for values, T for terms, E for expressions) with the following rules:
1. Eval(V)=V
2. Eval((E))=Eval(E)
3. Eval(C₀|C₁)=C where the names of C={n|n in C₀ xor C₁} (assuming C₀ and C₁ have name(s) in common—otherwise C₀|C₁ is a value)
4. Eval(V|C)=Eval(C₀| . . . |Cₙ|C) (or this case reduces to one above)=C0|Eval(C₁| . . . |Cₙ|C) if C₀ and C don't share a name Eval(Eval(C₀|C)|C₁| . . . |Cₙ) otherwise
5. Eval(V|(E))=Eval(V|Eval(E))
6. Eval((E)|V)=Eval(Eval(E)|V)
7. Eval(T₀|T₁|T₂)=Eval(Eval(T₀|T₁|T₂)

Two components are equal if they have the same name values. Thus, the order of names does not distinguish components. Equality can also be extended to cover expressions: E=E′⇄Eval(E)=Eval(E′). Following are some examples of evaluation expressions indicating the corresponding rules that have been used:
1. [a, b]|[b, c]=[a, c] (rule 3)
2. [a, b]|([b, c]|[b, d])=[a, b]|[c, d] (rule 5, rule 3, . . . )
3. [a, b]|[c, d]|[b, e]|=[a, e]|[c, d] (rule 4, rule 3, . . . )

These described definitions for components, connected components, operations, expressions, values, names, terms, evaluation function, evaluation rules, and equality can be used to specify transform relationships that are stored in transform schema 109. FIGS. 5A through 5C depict example diagrammatic representations (e.g., business models) of connected business components.

FIG. 5A depicts business component 501. Business component 501 includes names (or connections to other business components) [n₀, n₁, . . . , nₘ].

FIG. 5B depicts business model 502. Business model 502 includes a connection between component x and component y. The expression, PIPE=[x, y] can be used to algebraically represent business model 502.

FIG. 5C depicts business model 503. Business model 503 includes a more detailed view of component 501. Within business model 503, T=(EXPRESSION), where n₀, n₁, . . . , nₘ are the names of Eval(EXPRESSION) and the names on the term shape are connected to the corresponding names of the diagram of EXPRESSION.

FIG. 5D depicts business model 504. Business model 504 includes a plurality of connected terms represented by the expression T₀|T₁| . . . Tₙ, where T₀, T₁, . . . , Tₙ are the terms. A line is drawn joining same names of distinct term diagrams. A name on a term can be singly connected. If more than two terms share the same name they are connected in pairs left-to-right from the expression. The term shapes can be either those for components or parenthesized expressions as described above.

FIG. 5E depicts business model 505. Business model 505 includes a connection between component x₁ and component y_{1.} Thus, components can be joined diagrammatically by juxtaposing their same names instead of connecting those using lines. This is applicable particularly when some of the components are represented with connector shapes such as thick lines etc. For example, [x]|PIPE=[x, y]|[y].

The functionality depicted in FIGS. 5A through 5C can also be used to specify transform relationships that are stored in transform schema 109.

Method 300 includes an act of transforming the one or more business components from the initial level of detail to the updated level of detail in accordance with the transform relationships (act 304). For example, transform module 103, level of detail module 104 can interoperate with transform relationships included in transform schema 109 to transform a portion of capability model 122 from an initial level of detail to an update level of detail in accordance with the transform relationships. An updated level of detail can include more or less detail than the initial level of detail.

Referring now to FIG. 6A, FIG. 6A depicts a diagrammatic representation 600 of a business model. Depicted in diagrammatic representation 600 are business components 601, 603, 607, and 609. Business components 601 and 603 are connected through port 602 (e.g., a business component connection), business components 603 and 607 are connected through ports 604 and 606, business components 606 and 608 are connoted through port 608. Thus, the components of diagrammatic representation 600 can be algebraically represented as Component 601 =[port 602], Component 603=[port 602, port 604, port 606], Component 607 =[port 604, port 606, port 608], Component 609=[port 608].

The expression C601|C603|C607|C609 (using ‘C’ as an abbreviation for “Component”) defines the diagrammatic representation 600 algebraically. As depicted in FIG. 6B, the expression C601|C603|C607|C609 is equal to the expression to (C611=C601|C603)|C607|C609. Evaluating C611 yields C611=[port 604, port 606]. Thus, common port 602 is abstracted out and the level of detail is decreased.

Method 300 includes an act of modeling the one or more business components with the updated level of detail such that one portion of the accessed business model retains the initial level of detail and another portion of the accessed business model is updated to the updated level of detail (act 305). For example, modeling model 103 can model some business components of capability model 122 with the initial level of detail and some business components of capability model 122 with the updated level of detail. Thus, some business components of capability model 122 retain the initial level of detail and other components of capability model 122 are updated to the updated level of detail. Modeling module 103 can output the transformed model as transformed business model 112.

Referring now to FIG. 6C, FIG. 6C depicts that some components of model 600 have been modeled with the updated level of detail (component 611). Thus, portions of model 600 (components 607 and 609) retain the initial level of detail and another portion model 600 (component 611) is updated to the updated level of detail. Accordingly, in response to user input, the level of detail in portions of a business model can be selectively adjusted.

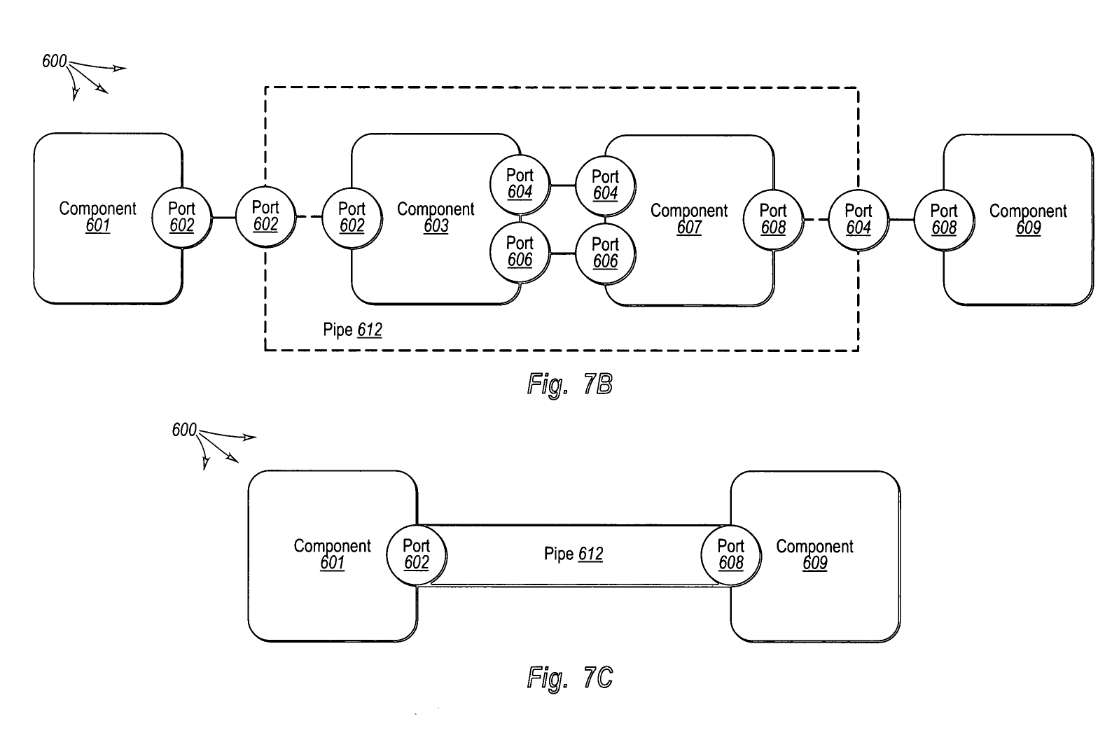

FIGS. 7A, 7B, and 7C illustrate a second example of transforming a portion of a business model to have a different level of detail. FIG. 7A depicts the business model 600. As depicted in FIG. 7B, the expression C601|C603|C607|C609 is equal to the expression to C601|(Pipe 612=(C603|C607))|C609. Evaluating Pipe 612 yields Pipe 612=[port 602, port 608]. Thus, components 603 and 607 are abstracted out and the level of detail is decreased. Referring now to FIG. 7C, FIG. 7C depicts that some components of model 600 have been modeled with the updated level of detail (pipe 612). Thus, portions of model 600 (components 607 and 609) retain the initial level of detail and another portion model 600 (Pipe 612) is updated to the updated level of detail.

Although examples of reducing the level of detail have been expressly described, it should be understood that embodiments of the present invention can also be used to increase the level of detail. For example, it may be that model 600 depicted in FIG. 6C represents the initial level detail. Model 600 can be transformed (using a decomposition operator) to that depicted in FIG. 6B and then modeled (with increased detail) as depicted FIG. 6A.

Business models can include detail data for representing business components at various levels of detail. Thus, if an initial of level of detail is somewhat reduced from the maximum level of detail, level of detail module 104 can store other detail data representing increased levels of detail for use in subsequent transformations. When a an indication (e.g., user input 114) of increased level of detail is received, level of detail module 104 can refer back to the stored detail data to transformation an initial level of detail to an increased level of detail.

When a model does not include data for various levels of detail, level of detail module 104 can retain abstracted out detail data such that a model can at least be reverted back the initial level of detail.

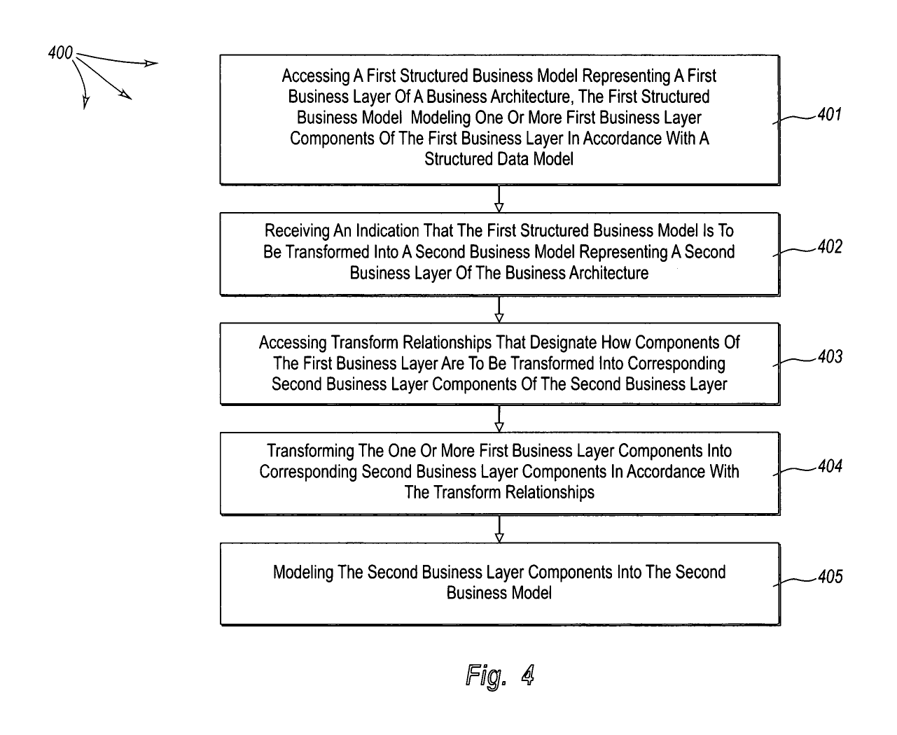

FIG. 4 illustrates an example flowchart of a method 400 for transforming components of one type of business model into corresponding components of another type of business model. Method 400 will be descried with respect to the components in computer architecture 100.

Method 400 includes an act of accessing a first structured business model representing a first business layer of a business architecture (act 401). For example, modeling module 103 can access capability model 122. The first structured business model models one or more first business layer components of the first business layer in accordance with a structured data model. For example, capability model 102 can model one or more business capabilities of business capability layer 121 in accordance with business capability modeling schema 200.

Method 400 includes an act of receiving an indication that the first structured business model is to be transformed into a second business model representing a second business layer of the business architecture (act 402). For example, user-interface 102 can receive user-input 114 indicating that capability model 122 is to be transformed into a service model representing service network layer 131. User-interface 102 can transfer user-input 114 to layer selection module 107. Transforming a first structured busies model to a second business model can include transforming any of a variety of different business layers, such as, for example, between business capability layer 122, service network layer 131, business process flow layer 141, business organization layer 151, and geographical layer 161.

Method 400 includes an act of accessing transform relationships that designate how components of the first business layer are to be transformed into corresponding second business layer components of the second business layer (act 403). For example, transformation module 105 can access transform schema 109 that includes transform relationships designating how business capability components are to be transformed into service network components. Transformation relationships can indicate, for example, what IT infrastructure is needed to implement a corresponding business capability.

Transformation relationships for other transformations can include other appropriate data. For example, transformation relationships to transform a service model to an organizational model can indicate what personnel support what portions of an IT infrastructure. Transform relationships between a process flow model and a geographical model can indicate where process flows occur. It would be apparent to one skill in the art, after having reviewed this description, that other transformation relationships for transforming models between other business layers can also be used.

Method 400 includes an act of transforming the one or more first business layer components into corresponding second business layer components in accordance with the transform relationships (act 404). For example, layer selection model 107 and transformation module 103 can interoperate with transformation relationships in transform schema 109 to transform business components of capability model 122 into corresponding business components of service network layer 131.

Method 400 includes an act of modeling the second business layer components into the second business model (act 405). For example, modeling module 103 can model business components of service network layer 131 in to a service model. Modeling module 103 can output the service model as transformed business model 112.

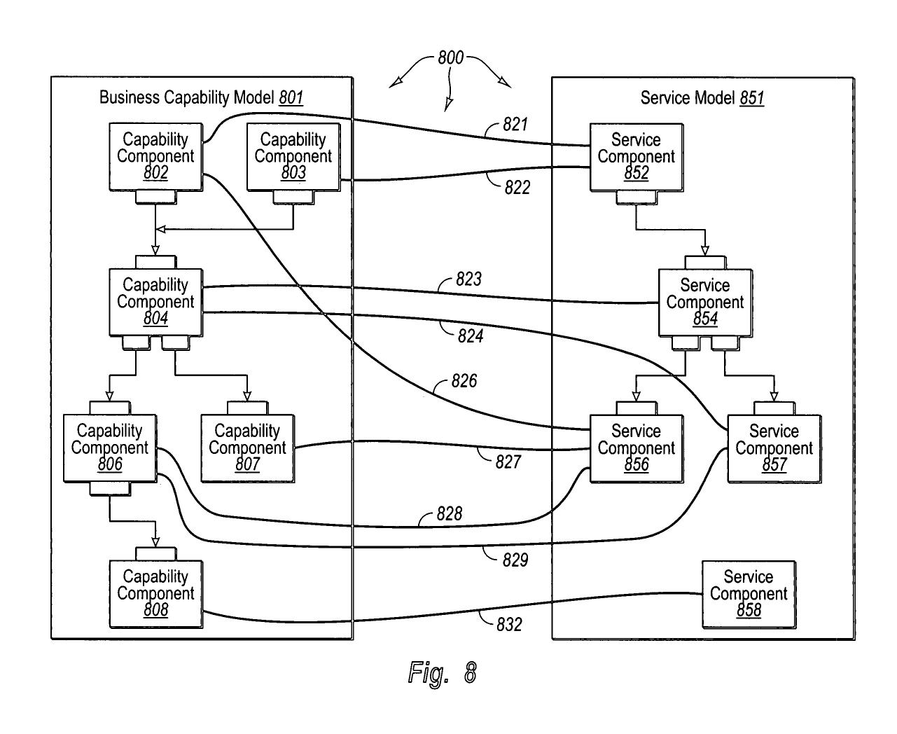

FIG. 8 illustrates a business capability model 801 of a business capability layer and a corresponding transformed service model 851 of a service network layer (i.e., a network of services). It may be that modeling module 103 receives business capability model 801 and transforms business capability model 801 into service model 851. Business capability model 801 includes existing capability components 802, 803, 804, 806, 807, and 808. Service model 851 includes existing service components 852, 854, 856, 857, and 858. Connections 821, 822, 823, 824, 826, 827, 828, and 829 visually represent corresponding transform relationships that were used to transform business capability model 801 to service model 851. For example, a transform relationship can indicate that service components 852 and 856 are used to implement capability component 802 (as indicated by connections 821 and 826).

It may be that a service component supports a plurality of different capability components. For example, service component 452 supports both capability component 402 and 403 (as depicted by connections 421 and 422 respectively). It may also be that a plurality of service components supports a capability component. For example, service components 454 and 457 both support capability component 404 (as depicted by mappings 423 and 424). Thus, various one-to-one, many-to-one, one-to-many, and many-to-many correspondences can result from transforming between business models of different business layers.

As previously described, various different data models can be used to model different business layers. Thus in some embodiments, data models can include at least one business capability modeling schema for modeling a business capability layer, at least one business organizational schema for modeling a business organizational layer, at least one business process flow modeling schema for modeling a business process flow layer, at least one service network layer business modeling schema for modeling a service network layer, etc. Corresponding transformation schemas can be used to convert between schemas for specified business layers. Thus, modeling model 103 can have access to plurality of transformation schemas for transforming between the various different business layers, such as, for example, a capability to service transformation schema, an organizational to process flow transformation schema, etc.

Embodiments of the present invention provide mechanisms to transform levels of detail in business models. Users can configure levels of detail such that the appropriate amount of detail for a given task is provided. Further, users can transform models between different business layers without having to associate or understand the structures of the different business layers. Accordingly, users are provided business context for completing tasks more efficiently without being overwhelmed by unneeded business details and without lacking all the relevant business details.

However, while description of the invention has primarily been directed to transforming business models, it should be understood that models of any arbitrary network can be transformed in accordance with the principles of the present invention. That is, embodiments of the invention can also be used to transform models of other types of networks (in addition to business network models), such as, for example, a network of software components. For example, a method can be implemented to transform a portion of arbitrary model of a network to have a different level of detail.

The method includes accessing an arbitrary model of a network. For example, computer system 101 can access a model of a software component network. The software components in the software component network can be modeled with an initial level of detail.

The method includes an act of receiving an indication that one or more of the modeled components are to be modeled with an updated level of detail. For example, user-interface 102 can receive user-input 114 indicating that the level of detail for one or more software components the model of the software component network is to be changed. User-interface 102 can transfer user-input 114 to level of detail module 104. Changing a level of detail can include increasing and/or decreasing the level of detail of all, some, or one of the software components in a model of software component model. For example, a second level of detail can indicate that the level of detail for a portion of the model of the software component network is to be increased or decreased from the initial level of detail.

The method includes an act of accessing transform relationships that designate how modeled components are to be transformed from the initial level of detail to the updated level of detail. For example, transform module 105 can access an appropriate transform schema. The transform schema can include transform relationships (similar to those previously described) that indicate how software components included in the model of the software component network are to be transformed between various different levels of detail.

The method includes an act of transforming the modeled components from the initial level of detail to the updated level of detail in accordance with the transform relationships. For example, transform module 103, level of detail module 104 can interoperate with transform relationships included in the appropriate transform schema to transform a portion of a model of a software component network from an initial level of detail to an update level of detail in accordance with the transform relationships. An updated level of detail can include more or less detail than the initial level of detail.

The method includes an act of modeling the one or more modeled components with the updated level of detail such that one portion of the accessed network model retains the initial level of detail and another portion of the accessed network model is updated to the updated level of detail. For example, modeling model 103 can model some software components of the model of the software component network with the initial level of detail and can model other software components of the model of the software component network with the updated level of detail. Thus, some software components of the model of the software component network retain the initial level of detail and other software components of the model of the software component network are updated to the updated level of detail. Modeling module 103 can output the transformed model as a transformed model of the software component network.

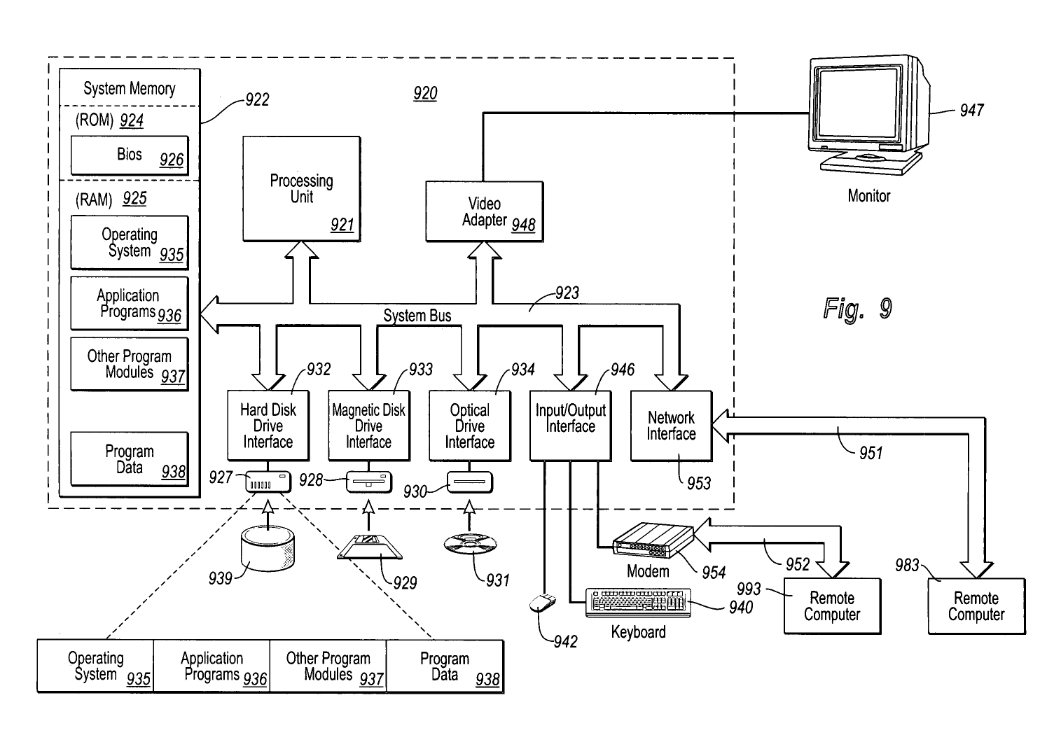

FIG. 9 and the following discussion are intended to provide a brief, general description of a suitable computing environment in which the invention may be implemented. Although not required, the invention can be implemented in the general context of computer-executable instructions, such as program modules, being executed by computer systems. Generally, program modules include routines, programs, objects, components, data structures, and the like, which perform particular tasks or implement particular abstract data types. Computer-executable instructions, associated data structures, and program modules represent examples of the program code means for executing acts of the methods disclosed herein.

With reference to FIG. 9, an example system for implementing the invention includes a general-purpose computing device in the form of computer system 920, including a processing unit 921, a system memory 922, and a system bus 923 that couples various system components including the system memory 922 to the processing unit 921. Processing unit 921 can execute computer-executable instructions designed to implement features of computer system 920, including features of the present invention. The system bus 923 may be any of several types of bus structures including a memory bus or memory controller, a peripheral bus, and a local bus using any of a variety of bus architectures. The system memory includes read only memory (“ROM”) 924 and random access memory (“RAM”) 925. A basic input/output system (“BIOS”) 926, containing the basic routines that help transfer information between elements within computer system 920, such as during start-up, may be stored in ROM 924.

The computer system 920 may also include magnetic hard disk drive 927 for reading from and writing to magnetic hard disk 939, magnetic disk drive 928 for reading from or writing to removable magnetic disk 929, and optical disk drive 930 for reading from or writing to removable optical disk 931, such as, or example, a CD-ROM or other optical media. The magnetic hard disk drive 927, magnetic disk drive 928, and optical disk drive 930 are connected to the system bus 923 by hard disk drive interface 932, magnetic disk drive-interface 933, and optical drive interface 934, respectively. The drives and their associated computer-readable media provide nonvolatile storage of computer-executable instructions, data structures, program modules, and other data for the computer system 920. Although the example environment described herein employs magnetic hard disk 939, removable magnetic disk 929 and removable optical disk 931, other types of computer readable media for storing data can be used, including magnetic cassettes, flash memory cards, digital versatile disks, Bernoulli cartridges, RAMs, ROMs, and the like.

Program code means comprising one or more program modules may be stored on hard disk 939, magnetic disk 929, optical disk 931, ROM 924 or RAM 925, including an operating system 935, one or more application programs 936, other program modules 937, and program data 938. A user may enter commands and information into computer system 920 through keyboard 940, pointing device 942, or other input devices (not shown), such as, for example, a microphone, joy stick, game pad, scanner, or the like. These and other input devices can be connected to the processing unit 921 through input/output interface 946 coupled to system bus 923. Input/output interface 946 logically represents any of a wide variety of different interfaces, such as, for example, a serial port interface, a PS/2 interface, a parallel port interface, a Universal Serial Bus (“USB”) interface, or an Institute of Electrical and Electronics Engineers (“IEEE”) 1394 interface (i.e., a FireWire interface), or may even logically represent a combination of different interfaces.

A monitor 947 or other display device is also connected to system bus 923 via video interface 948. Speakers or other audio output device is also connected to system bus 923 via an audio interface. Other peripheral output devices (not shown), such as, for example, printers, can also be connected to computer system 920.

Computer system 920 is connectable to computer networks, such as, for example, an office-wide or enterprise-wide computer network, a home network, an intranet, and/or the Internet. Computer system 920 can exchange data with external sources, such as, for example, remote computer systems, remote applications, and/or remote databases over such computer networks.

Computer system 920 includes network interface 953, through which computer system 920 receives data from external sources and/or transmits data to external sources. As depicted in FIG. 9, network interface 953 facilitates the exchange of data with remote computer system 983 via link 951. Network interface 953 can logically represent one or more software and/or hardware modules, such as, for example, a network interface card and corresponding Network Driver Interface Specification (“NDIS”) stack. Link 951 represents a portion of a computer network (e.g., an Ethernet segment), and remote computer system 983 represents a node of the computer network.

Likewise, computer system 920 includes input/output interface 946, through which computer system 920 receives data from external sources and/or transmits data to external sources. Input/output interface 946 is coupled to modem 954 (e.g., a standard modem, a cable modem, or digital subscriber line (“DSL”) modem), through which computer system 920 receives data from and/or transmits data to external sources. As depicted in FIG. 9, input/output interface 946 and modem 954 facilitate the exchange of data with remote computer system 993 via link 952. Link 952 represents a portion of a computer network and remote computer system 993 represents a node of the computer network.

While FIG. 9 represents a suitable operating environment for the present invention, the principles of the present invention may be employed in any system that is capable of, with suitable modification if necessary, implementing the principles of the present invention. The environment illustrated in FIG. 9 is illustrative only and by no means represents even a small portion of the wide variety of environments in which the principles of the present invention may be implemented.

In accordance with the present invention, user-interfaces, level of detail modules, layer selection modules, and transformation modules as well as associated data, including business models and transformation schemas, can be stored and accessed from any of the computer-readable media associated with computer system 920. For example, portions of such modules and portions of associated program data may be included in operating system 935, application programs 936, program modules 937 and/or program data 938, for storage in system memory 922.

When a mass storage device, such as, for example, magnetic hard disk 939, is coupled to computer system 920, such modules and associated program data may also be stored in the mass storage device. In a computer network environment, program modules depicted relative to computer system 920, or portions thereof, can be stored in remote memory storage devices, such as, system memory and/or mass storage devices associated with remote computer system 983 and/or remote computer system 993. Execution of such modules may be performed in a distributed environment as previously described.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed and desired secured by United States Letters Patent is:

1. At a computer system, a method transforming the level of detail in a portion of a business model, the method comprising:
an act of accessing a business model representing a business layer of a business architecture, the business model modeling a plurality of business components of the business layer in accordance with a structured data model, the plurality of business components modeled with an initial level of detail;
an act of receiving an indication that one or more of the plurality of business components are to be modeled with an updated level of detail;
an act of accessing transform relationships that designate how business components are to be transformed from the initial level of detail to the updated level of detail;
an act of transforming the one or more business components from the initial level of detail to the updated level of detail in accordance with the transform relationships; and
an act of modeling the one or more business components with the updated level of detail such that one portion of the accessed business model retains the initial level of detail and another portion of the accessed business model is updated to the updated level of detail.

2. The method as recited in claim 1, wherein the act of accessing a business model representing a business layer of a business architecture comprises an act of accessing business model representing a business layer selected from among a business capability layer, a service network layer, a business process flow layer, a business organizational layer, and a geographic layer.

3. The method as recited in claim 1, wherein the act of receiving an indication that one or more of the plurality of business components are to be modeled with an updated level of detail comprises an act of receiving user-input.

4. The method as recited in claim 1, wherein the act of accessing transform relationships that designate how business components are to be transformed from the initial level of detail to the updated level of detail comprises an act of accessing a transform schema.

5. The method as recited in claim 1, wherein the act of accessing transform relationships that designate how business components are to be transformed from the initial level of detail to the updated level of detail comprises an act of accessing transform relationships that indicate how business components can be composed to decrease the level of detail.

6. The method as recited in claim 1, wherein the act of accessing transform relationships that designate how business components are to be transformed from the initial level of detail to the updated level of detail comprises an act of accessing transform relationships that indicate how business components can be decomposed to increase the level of detail.

7. The method as recited in claim 1, wherein the act of transforming the one or more business components from the initial level of detail to the updated level of detail in accordance with the transform relationships comprises an act of evaluating an algebraic expression in accordance with specified evaluation rules.

8. The method as recited in claim 1, wherein the act of modeling the one or more business components with the updated level of detail comprises an act of increasing the level of detail of the one or more business components.

9. The method as recited in claim 1, wherein the act of modeling the one or more business components with the updated level of detail comprises an act of decreasing the level of detail of the one or more business components.

10. The method as recited in claim 14, wherein the act of modeling the one or more business components with the updated level of detail comprises an act of modeling a user-specified configured amount of context for the one or more business components.

11. At a computer system, a method of transforming a business model representing one layer of a business architecture into a business model representing another different layer of the business architecture, the method comprising:
an act of accessing a first structured business model representing a first business layer of a business architecture, the first structured business model modeling one or more first business layer components of the first business layer in accordance with a structured data model;
an act of receiving an indication that the first structured business model is to be transformed into a second business model representing a second business layer of the business architecture;
an act of accessing transform relationships that designate how components of the first business layer are to be transformed into corresponding second business layer components of the second business layer;
an act of transforming the one or more first business layer components into corresponding second business layer components in accordance with the transform relationships; and
an act of modeling the transformed second business layer components into the second business model.

12. The method as recited in claim 11, wherein the act of accessing a first structured business model representing a first business layer of a business architecture comprises an act of accessing a first structured business model representing a business layer selected from among a business capability layer, a service network layer, a business process flow layer, a business organizational layer, and a geographic layer.

13. The method as recited in claim 11, wherein the act of receiving an indication that the first structured business model is to be transformed into a second business model representing a second business layer comprises an act of receiving an indication that a business capability model is to be transformed into a second business model selected form among a service model, a process flow model, an organizational model, and a geographical model.

14. The method as recited in claim 11, wherein the act of receiving an indication that the first structured business model is to be transformed into a second business model representing a second business layer comprises an act of receiving user-input.

15. The method as recited in claim 11, wherein the act of accessing transform relationships that designate how components of the first business layer are to be transformed into corresponding second business layer components of the second business layer comprises an act of accessing transform relationships that indicate how a components of business capability model is to be transformed to components of a second business layer selected from among a service network layer, a business process flow layer, a business organizational model layer, and a geographical layer.

16. The method as recited in claim 11, wherein the act of accessing transform relationships that designate how components of the first business layer are to be transformed into corresponding second business layer components of the second business layer comprises an act of accessing transform relationships that indicate how data formats for the first business layer are to be transformed to data formats for the second business layer.

17. The method as recited in claim 11, wherein the act of transforming the one or more first business layer components into corresponding second business layer components in accordance with the transform relationships comprises an act of transforming business capability components into corresponding comments of a second business layer selected from among a service network layer, a business process flow layer, a business organizational model layer, and a geographical layer.

18. A computer program product for use at a computer system, the computer program product for implementing a method transforming the level of detail in a portion of a business model, the computer program product comprising one or more computer-readable media have stored thereon computer-executable instructions that, when executed by a processor, cause the comptuer system to perform the following:
access a business model representing a business layer of a business architecture, the business model modeling a plurality of business components of the business layer in accordance with a structured data model, the plurality of business components modeled with an initial level of detail;
receive an indication that one or more of the plurality of business components are to be modeled with an updated level of detail;
access transform relationships that designate how business components are to be transformed from the initial level of detail to the updated level of detail;
transform the one or more business components from the initial level of detail to the updated level of detail in accordance with the transform relationships; and
model the one or more business components with the updated level of detail such that one portion of the accessed business model retains the initial level of detail and another portion of the accessed business model is updated to the updated level of detail.

19. The computer program product as recited in claim 18, wherein computer-executable instructions that, when executed, cause the computer system to access transform relationships that designate how business components are to be transformed from the initial level of detail to the updated level of detail comprise computer-executable instructions that, when executed, cause the computer system to access a transform schema.

20. The computer program product as recited in claim 18, wherein computer-executable instructions that, when executed, cause the computer system to access transform relationships that designate how business components are to transform the one or more business components from the initial level of detail to the updated level of detail in accordance with the transform relationships comprise computer-executable instructions that, when executed, cause the computer system to evaluate an algebraic expression in accordance with specified evaluation rules.

21. At a computer system, a method transforming the level of detail in a portion of an arbitrary network model, the method comprising:
an act of accessing an arbitrary model of a network, the arbitrary model modeling a plurality of components included in the network with an initial level of detail;
an act of receiving an indication that one or more of the modeled components are to be modeled with an updated level of detail;
an act of accessing transform relationships that designate how one or more modeled components are to be transformed from the initial level of detail to the updated level of detail;
act of transforming the one or more modeled components from the initial level of detail to the updated level of detail in accordance with the transform relationships; and
an act of modeling the one or more modeled components with the updated level of detail such that one portion of the accessed model of a network retains the initial level of detail and another portion of the accessed model of a network is updated to the updated level of detail

22. The method as recited in claim 21, wherein the act of accessing an arbitrary model of a network comprises an act of accessing a model of a software component network.
